(19) United States
(12) Patent Application Publication
(10) Pub. No.: US 2013/0238444 A1
(43) Pub. Date: Sep. 12, 2013

(54) System and Method For Promotion and Networking of at Least Artists, Performers, Entertainers, Musicians, and Venues

(71) Applicants: Sam Munaco, Auburn Hills, MI (US); Chris Ciaramitaro, Shelby Township, MI (US)

(72) Inventors: Sam Munaco, Auburn Hills, MI (US); Chris Ciaramitaro, Shelby Township, MI (US)

(21) Appl. No.: 13/547,569

(22) Filed: Jul. 12, 2012

Related U.S. Application Data
(60) Provisional application No. 61/506,674, filed on Jul. 12, 2011.

(51) Int. Cl. G06Q 30/02; G06Q 50/00

(52) U.S. Cl. CPC G06Q 30/0269; G06Q 50/01
USPC 705/14.66; 705/14.73

(57) ABSTRACT

Methods and systems for promotion and networking of at least artist and fans which enable artist to upload media files to a web site which can be searched, played and rated by fans. Demographic information profiles of fans can be created from fan ratings for each artist which can then be used for various purposes including artist marketing and providing targeted advertising when fans plays or views an artist's media.

### CROSS-REFERENCE TO RELATED APPLICATIONS

This application claims the benefit of U.S. provisional Application No. 61/506,674 filed Jul. 12, 2011, the disclosure of which is incorporated in its entirety by reference herein.

### BACKGROUND OF INVENTION

1. Field of the Invention

The invention generally relates to a system and method for providing a social network service for the promotion and networking of members of the social network service, and more specifically, wherein members include at least artists, performers, entertainers, musicians, and venues.

2. Description of the Related Art

Aspiring artists, performers, entertainers, musicians, and venues currently have access to a select number of websites that provide services to facilitate promotion of artists, performers, entertainers, magicians, or venues who become members of the service. However, such services fail to maximize promotional exposure of their members.

Recently, there has been an explosion in social networking The most popular social networks of today are expansive and free, some having in excess of 350 million members. However, there is a need in the art to harness the influence of social networking to specific groups or activities. Specifically, there is a need to have a social network service designed to maximize promotional exposure of artists, performers, entertainers, musicians, and venues.

The present invention discloses a system and a method for the promotion and networking of end users such as artists, performers, entertainers, musicians, and venues. A social network service is provided which provides, inter alia, a means for the end users to become members of the social network service. A server is also provided wherein the server hosts the social network service.

### BRIEF DESCRIPTION OF THE DRAWINGS

Advantages of the present invention will be readily appreciated, as the same becomes better understood by reference to the following detailed description when considered in connection with the accompanying drawings wherein:

FIG. 1 shows a schematic diagram of the architecture for the system of the present invention;

FIG. 2 shows a chart of the web page hierarchy for the social network service of the present invention.

FIG. 2A shows a logical flow chart for a means for the end users to become members of the social network service, and a means for members to upload media files to the social network service of the present invention.

FIG. 2B shows a logical flow chart of a means in which members may request or search for other members of the social network service of the present invention.

FIG. 2C shows a logical flow chart of a means in which members navigate audio files according to the present invention.

FIG. 2D shows a logical flow chart of a means in which members may navigate video files according to the present invention.

FIG. 2E shows a logical flow chart for a means for the end users to view web shows and add web shows to a queue.

FIG. 2F shows a logical flow chart for a means in which members may view miscellaneous information of the social networking service.

FIG. 3 shows a screen capture of a homepage of the present invention.

FIGS. 4A and 4B shows a screen capture of a homepage for a member who is an entertainer, and a homepage for a member who is a venue.

FIG. 5 shows a logical flow chart of a means in which members may browse for media content and add content to a playlist.

FIG. 6 shows a screen capture of a page whereby members may search other members of the social network service.

FIG. 7 shows a logical flow chart of a means in which members may search and track artists.

FIG. 8 shows a logical flow chart of a means in which members may search for media files and add media files to a playlist.

FIG. 9 shows a screen capture of a page whereby the social network service provides a means for members to upload audio and video files to the server.

FIGS. 10A and 10B show screen captures of homepages for an audio file and a video file, respectively.

FIGS. 11A and 11B show screen captures of a page providing a means by which a member may access audio files and video files, respectively, of other members by utilizing a search tool.

FIGS. 12A and 12B show a logical flow chart of how to navigate the through the homepages of members who are venues, and a screen capture of a homepage of a member who is classified as a venues, respectively.

FIG. 13 shows a screen capture of a main page of the social network service of the present invention.

FIGS. 14A and 14B show respectively, a logical flow chart and screen capture of a means for members to provide a broadcast of at least one live event whereby the broadcast is accessible by other members of the social network service.

FIG. 15 shows a logical flow chart of a means in which artist members may enter into a music contest.

FIG. 16 shows a logical flow chart of a means in which members may transfer media files to another member's homepage.

FIG. 17 shows a logical flow chart of a means in which members may create a playlist on a member's homepage.

FIG. 18 shows a logical flow chart of a means in which artist members may enter information into a new feed.

FIG. 19 shows a logical flow chart for the directed advertisement system of the present invention.

FIG. 20 shows a computer generated report provided to advertisers.

FIG. 21 shows a computer generated report provided to an artist member informing them of the demographic information of listeners broken down by media file.

FIG. 22 shows a logical flow chart for creating mainstream artist radio station play and for correlating mainstream artists with artist members.

FIG. 23 shows a logical flow chart for compiling fan member information and supplying that fan member information to artist members.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

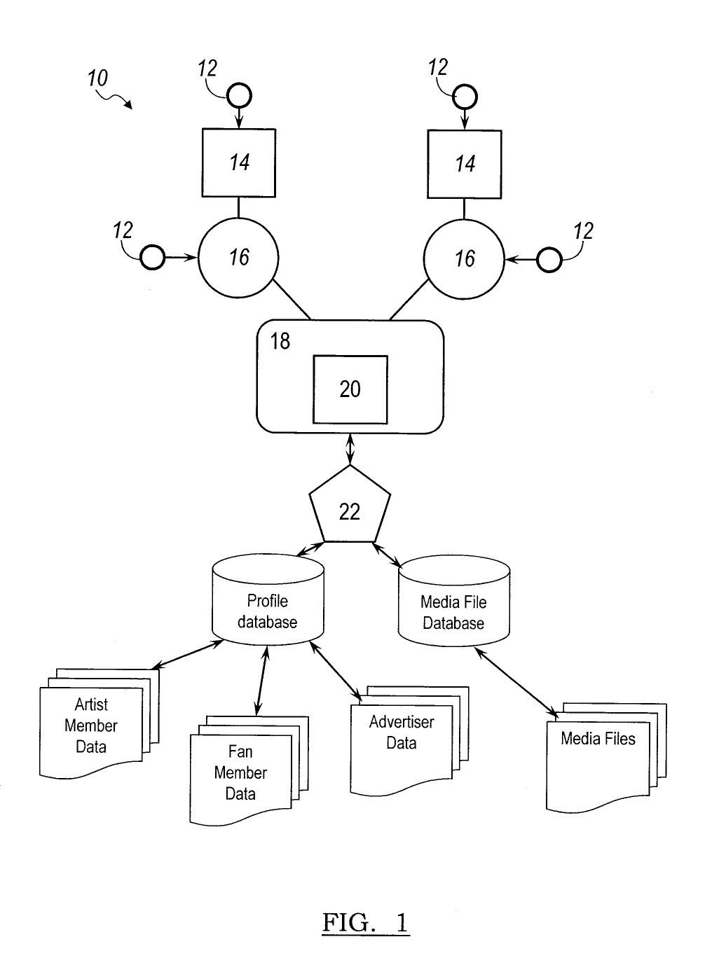

Referring to FIG. 1, a system 10 is provided according to the exemplary embodiment of the present invention. Typically, a plurality of end users 12 access the system 10 through a plurality of remote terminals 14. Suitable examples of remote terminals 14 include, but are not limited to, personal computers, portable phones, portable computers, wireless devices and the like. Through each remote terminal 14, the end users 10 typically access a local computer network 16 which in turn connects each of the remote terminals 14 to a computer network, such as the Internet 18. Each end user 12 may connect a remote terminal 14 to the Internet 18 according to any other suitable manner not specifically described herein. Traditionally, end users 12 communicate with the Internet 18 using a software application known in the art as a web browser.

A social network service 20 is provided for the end users. The social network service 20 comprises a plurality of related web pages containing digital information which an end user 12 may view from the remote terminal 14. Specifically, end users 12 interact with the social network service 20 from the remote terminal 14 by using the web browser and the Internet 18.

A server 22 accessible through the Internet 18 hosts the social network service 20. The server 22 is typically a machine or plurality of machines which communicate through the Internet 18 to respond to requests from or initiate commands to the remote terminal 14 of the end user 12. The server 22 also stores and relays electronic information provided by members of the social network service 20. Specifically, the electronic information provided by each member is accessible over the server 22 by other members of the social network service 20. It is to be appreciated that the server 22 may be any suitable type, including, but not limited to, any combination of proxy servers, cloud servers, mail servers, and the like. The server 22 maybe internally or externally connected to at least one database. Further, the recitation of a first database and a second database does not necessarily require that such databases are separate from one another, either with respect to the data storage location(s), device(s) and/or structure(s).

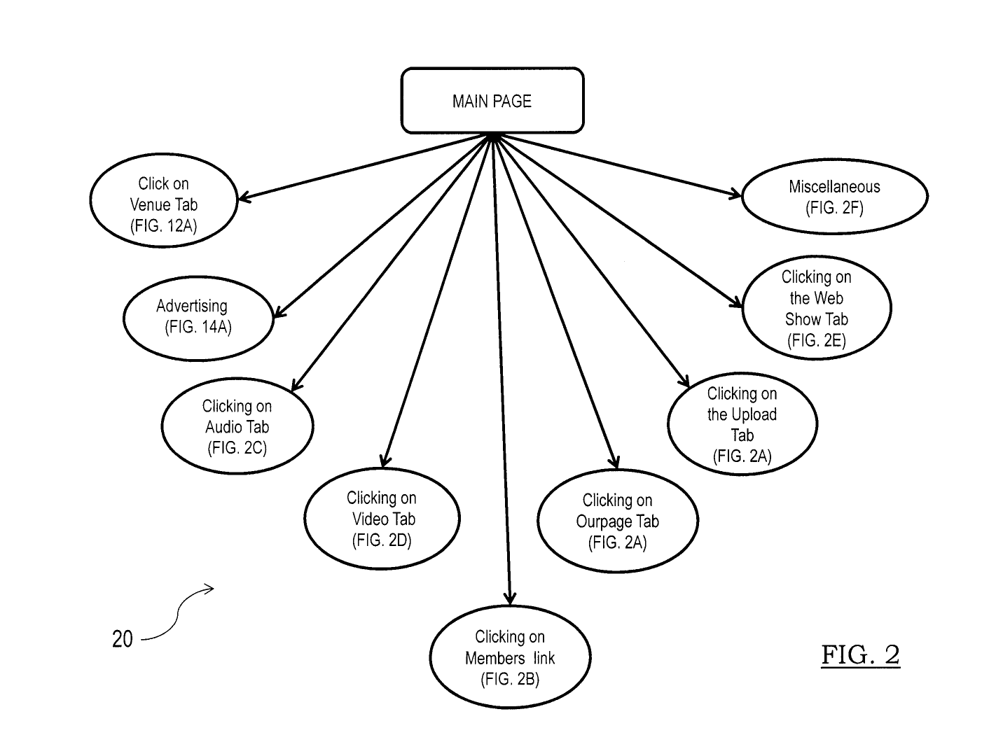

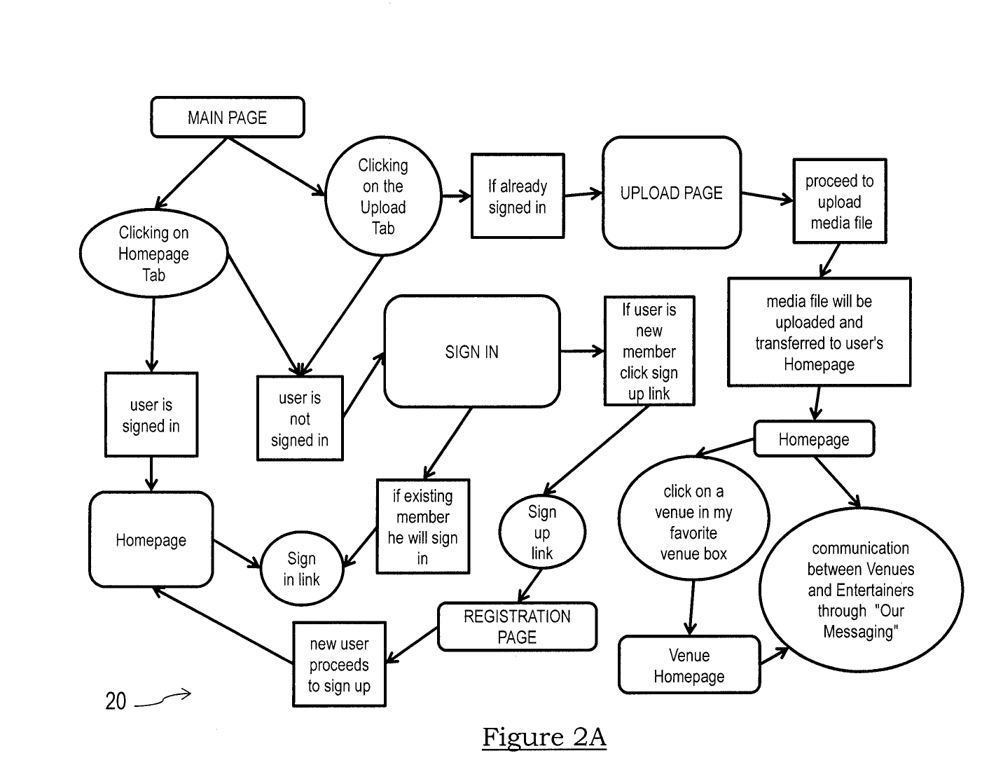

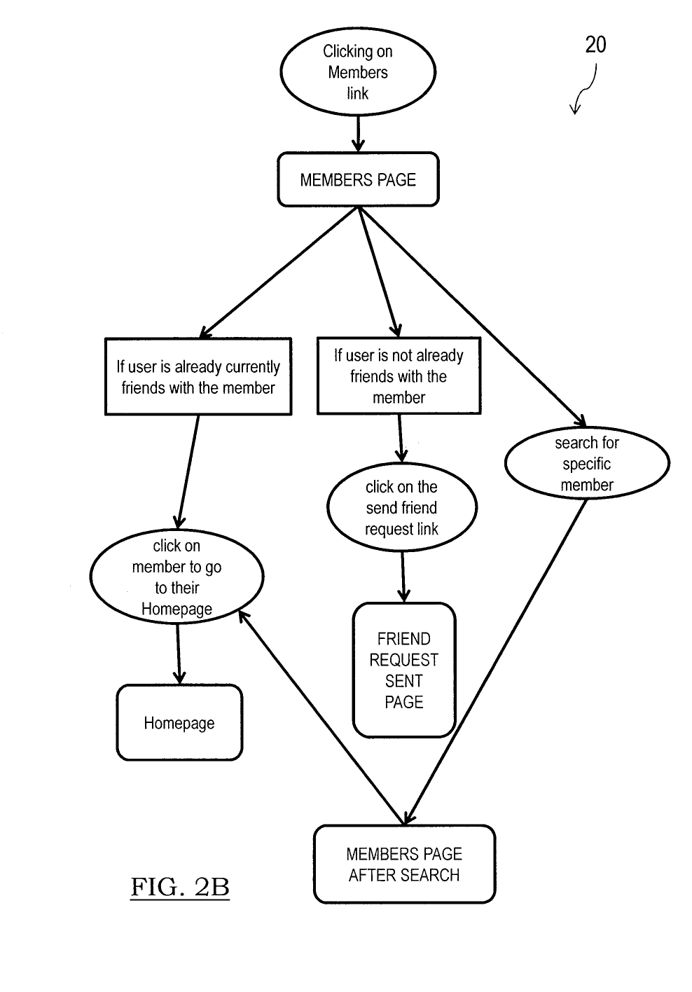

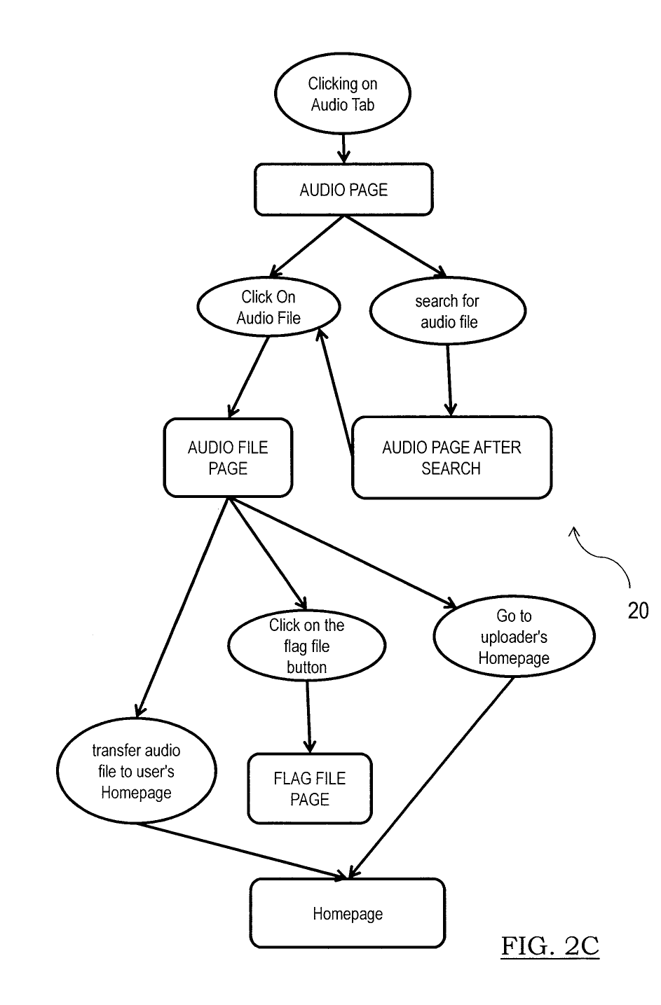

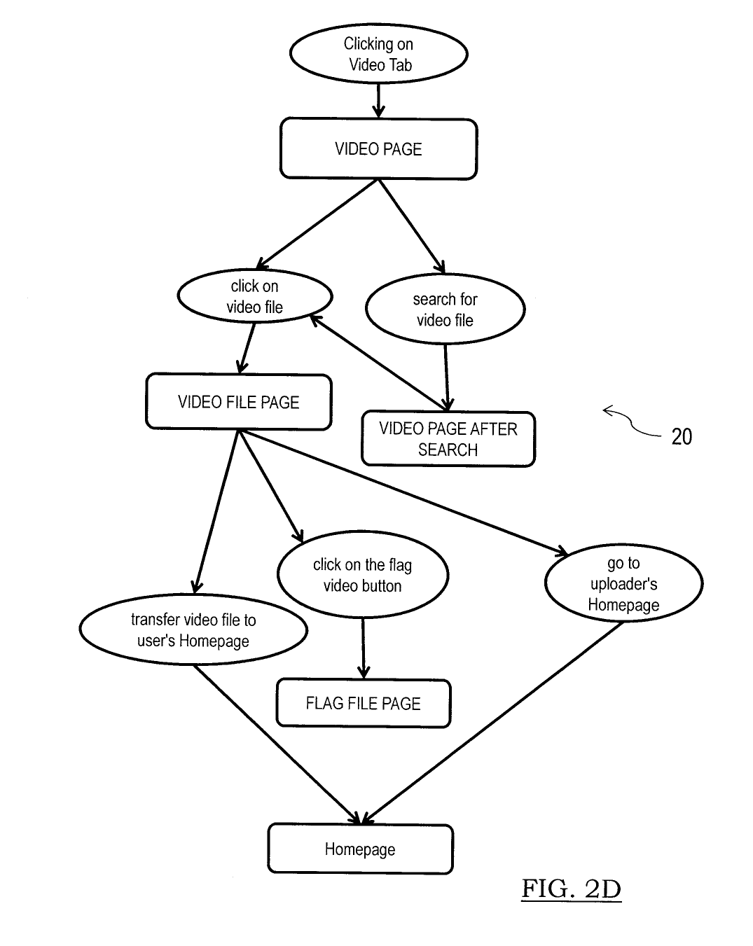

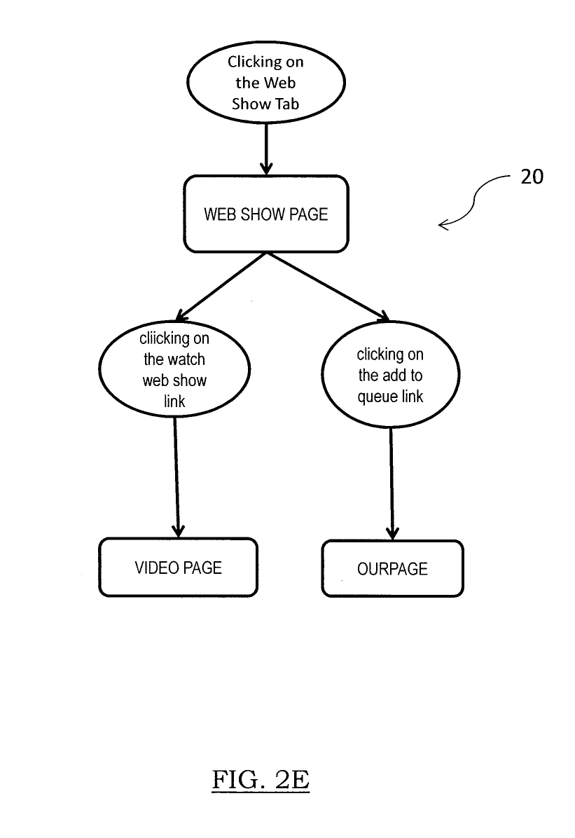

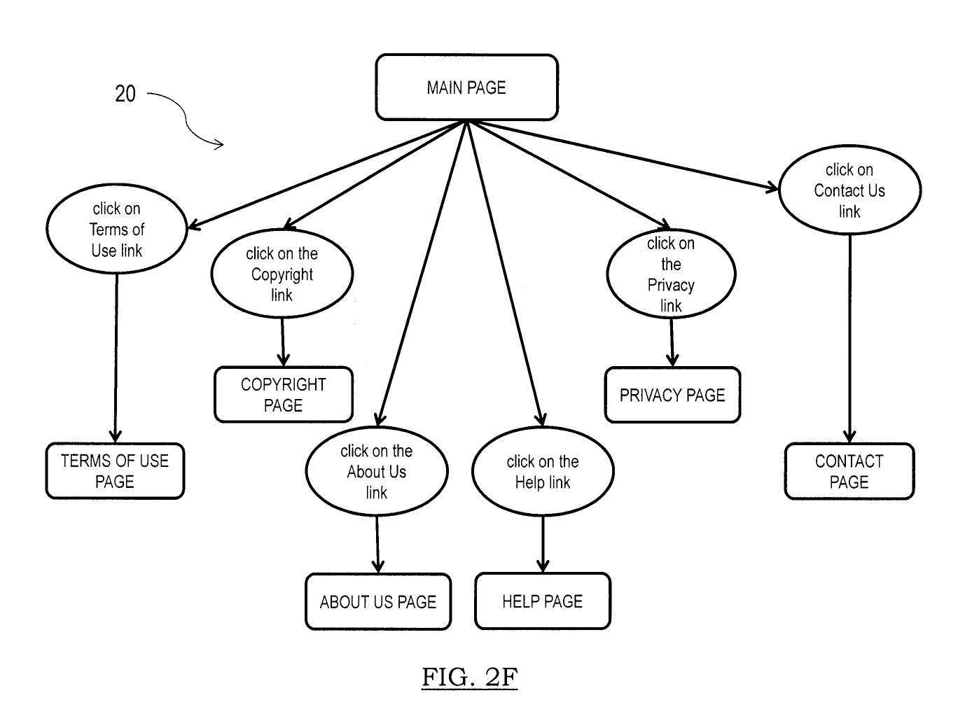

As illustrated in FIG. 2A, the social network service 20 provides a means for the end users 12 to become members of the social network service 20. Typically, the end users 12 input information, such as the name of the end user 12, to register to the social network service 20. After registration, the end user 12 becomes a member and may access the social network service 20 as a member at any given time thereafter. The social network service 20 may be free to members. Alternatively, the social network service 20 may require a fee from its members.

According to the exemplary embodiment of the present invention, the members of the social network service 20 include at least artists, performers, entertainers, musicians, talent agents, record labels or venues. It is to be appreciated that the present invention may include other types of members not specifically recited herein. Furthermore, the members may include individuals, businesses, or corporations. The social network service 20 typically enables end users 12 to define a user name by which the end user 12 will be identified by other members of the social network service 20. For example, an individual musician may become a member of the social network service 20 under a user name “John Doe.” Similarly, a corporation or business which owns a theater may become a member of the social network service under a user name “John Doe's Music Theater,” for example.

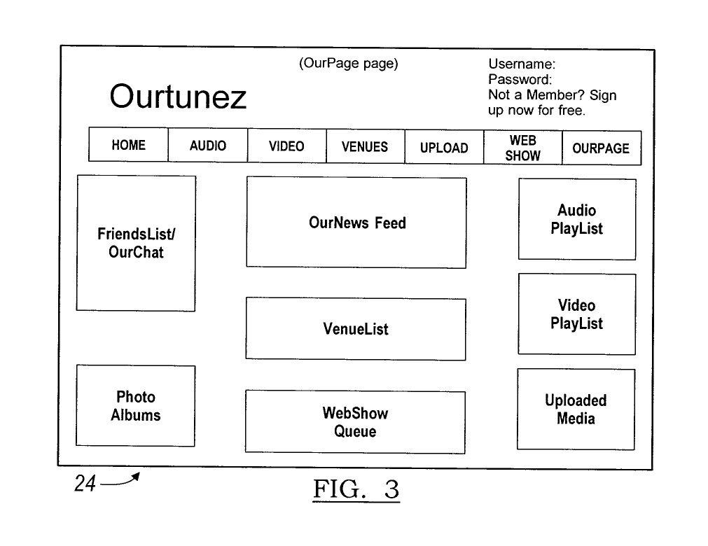

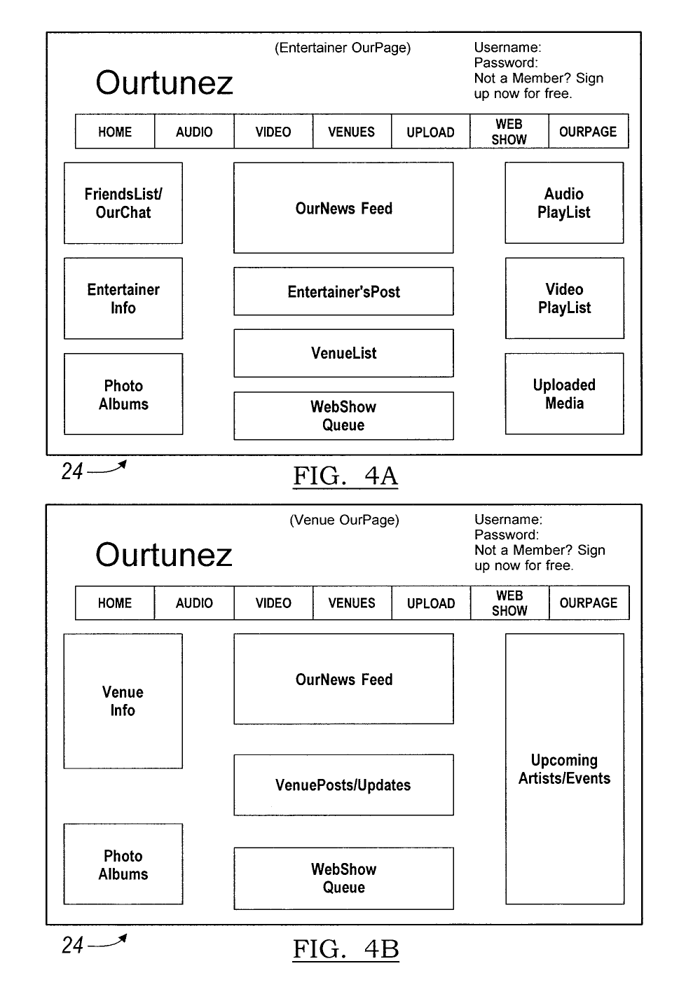

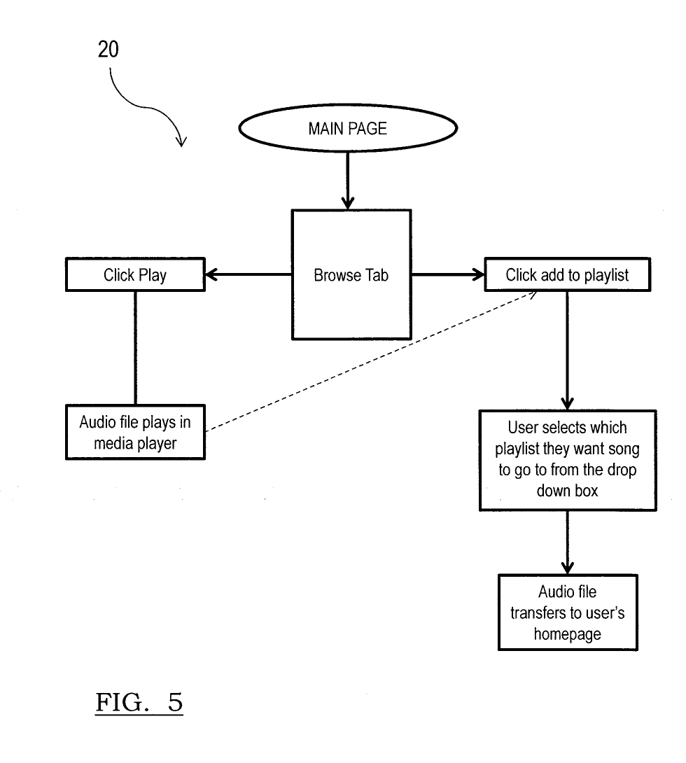

As illustrated in FIGS. 2A and 3, the social network service 20 provides a means for each member to create and maintain a homepage 24 after registering. A homepage 24 is web page or series of web pages dedicated to a particular entity, such as a member, a media file, a venue, or a company. In the preferred embodiment, each fan member, each artist member, each media file, each venue and each company may have their own home page. According to one embodiment of the present invention, as shown in FIGS. 4A and 4B, homepages 24 belonging to artists, performers, entertainers, musicians, and venues may provide additional and/or different features as compared to homepages 24 belonging to members who are not artists, performers, entertainers, musicians, and venues. For instance, a homepage of a musician may provide other members with information specifically geared towards other musicians such as musician information, musician posts, or the like. The homepage 24 provides a medium by which a member may effectively network and promote skills, services, and the like. A member may provide electronic information in various forms on their homepage 24. The electronic information provided by a member on a homepage 24 includes, but is not limited to, text and media files. The electronic information provided on a member's homepage 24 may include a profile, real time comments provided by the member, and demographic information. Applicant wishes to define demographic information as including, name, age, sex, geographic location, interests and entertainment preferences. Furthermore, the homepage 24 may include artist tracking, news feeds, personalized feeds of updates provided by friends, and the like. The homepage 24 of an artist member may include information about their band, pictures, upcoming tour information, such as, show dates, locations and the like.

A member may configure electronic information provided on the homepage 24 of the member to be publicly accessible to all other members of the social network service 20. Alternatively, a member may configure electronic information provided on the homepage 24 of the member to be accessible only to other members of the social network service 20 to whom the member has granted access. Specifically, as illustrated in FIG. 2B, access may be granted once a member and another member become “friends.” The term “friends” is broadly construed to include any form of association, personal or remote, between two members. After a member becomes “friends” with another member, a connection is established between the two members over the social network service 20. Specifically, a member who is a “friend” with another member is privileged to at least, view updates made to electronic information on the homepage 24 of the other member, and access to a “friends” list of the other member. It is to be appreciated that privileges of “friends” are not limited to privileges recited herein. Furthermore, the present application contemplates members who are not “friends” to be entitled to privileges described herein and privileges not directly recited herein.

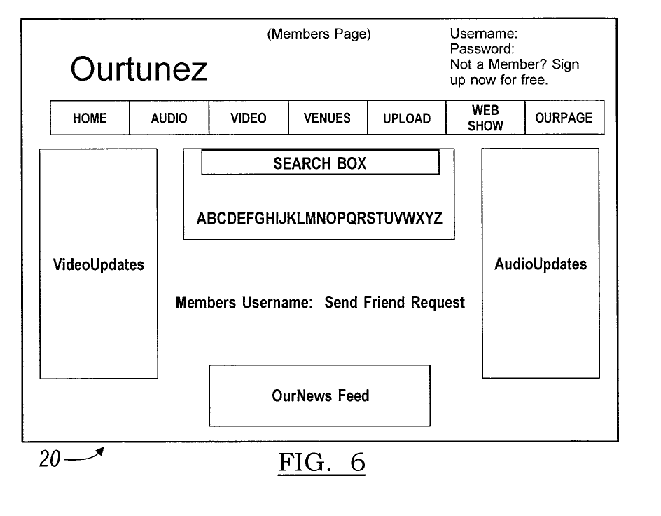

One method in which a member and another member may become “friends” is through a search. In particular, a member may search and find another member who has a homepage 24 that the member is interested in viewing. For example, as illustrated in FIGS. 6 and 2B, the social network service 20 may provide a means for members to search other members. Once a member desires to initiate a connection between another member, the member may send an electronic request to add the other member as a “friend.” Once the other member accepts the electronic request, the other member will appear on the “friends” list of the member. Members of the social network service 20 may send electronic requests to any other members. According to one embodiment of the present invention, the social network service 20 may be configured to allow homepages 24 belonging specifically to artists, performers, entertainers, musicians, and venues to always be publicly accessible to all other members of the social network service 20, while homepages 24 not belonging to artists, performers, entertainers, musicians, and venues to be accessible only to other members of the social network service 20 to which the member has granted access. It is to be appreciated that other configurations of private and/or public accessibility to homepages 24 are contemplated by the present invention.

The present application further contemplates a plurality of other features. For instance, members who have been added as a “friend” with another member may remove the other member as a “friend” thereby ultimately removing the other member from the friend list of the member. Furthermore, the present invention contemplates a means to allow a member to suggest a second member as a friend to a third member. In addition, the present invention contemplates the use of an algorithm to determine and suggest to a member which other members, if any, the member may be interested in meeting. Still another aspect of the present invention provides a means to categorize friends in a meaningful way. For instance, a member may categorize all friends that are venues. Alternatively, a member may categorize friends according to which members are “favorite,” or preferred friends of the member.

Media files which may be provided by members of the social network service 20 on the members homepage 24 include, but are not limited to, photos, audio files, and video files. Photos may be for promotional purposes. For example, a venue may provide several photos of the venue to allow other members to determine whether the venue is appropriate for their purposes. Furthermore, photos may be organized or categorized into photo albums. It is to be appreciated that photos may be used for other purposes not specifically described herein.

As illustrated in FIG. 2C, the social network service 20 provides a means by which members may navigate audio files. In addition, a member may provide an audio file on a homepage 24 of the member. The exemplary purpose for providing audio files on a homepage 24 is for promotional purposes. For example, an aspiring musician may want other members to preview an album produced by the aspiring musician. Likewise, a comedian may provide an audio file of a recent comedic performance to appeal to other members. However, audio files provided on the homepage 24 of the member need not be limited to the work of each respective member. Said differently, members may provide audio files from any source. Furthermore, the purpose of providing audio files on a homepage 24 may be for other purposes not specifically described herein.

As illustrated in FIG. 2D, the social network service 20 provides a means by which members may navigate video files. In addition, a member may provide a video file on a homepage 24 of the member. The exemplary purpose for providing video files on a homepage 24 is also for promotional purposes. For example, an aspiring artist may want other members to review a plurality of paintings painted by the aspiring artist. Likewise, a rock band may provide a video file of a music video recently created by the rock band. Video files provided on the homepage 24 need also not be limited to the work of each respective member. Said differently, members may provide video files from any source. Furthermore, the purpose of providing video files on a homepage 24 may be for other purposes not specifically described herein.

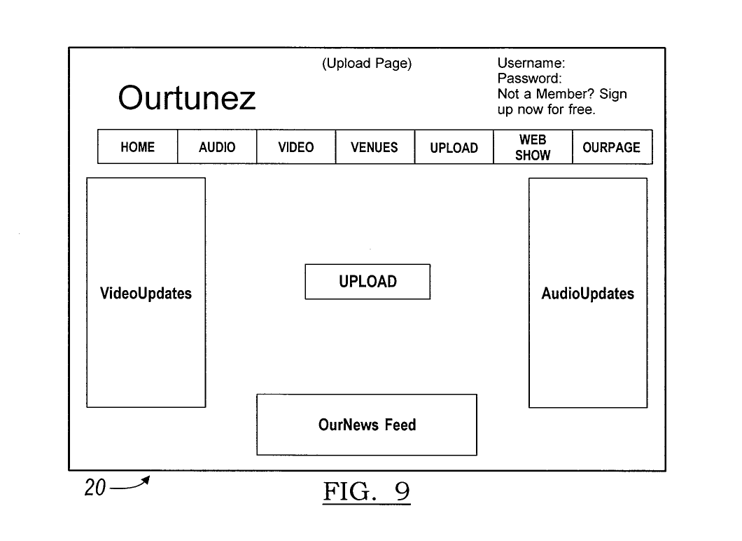

As illustrated in FIGS. 2A and 9, the social network service 20 provides a means for members to upload audio and video files to the server 22. Once uploaded, the audio and video files may be accessed from the social network service 20 in any manner known in the art. For example, the audio files and video files may be streamed such that the audio or video file is constantly received by and presented to a member while being delivered by a streaming provider. Alternatively, the audio file or video file may be downloaded using any suitable method. In addition, the homepage 24 may provide updates regarding audio and video files. Such updates may include new audio or video files provided by other members, changes in popularity of the audio or video file, and the like. It is to be appreciated that updates regarding audio and video files may be presented in any suitable manner on the social network service 20 including, but not limited to, while searching for audio or video files, or while searching for other members.

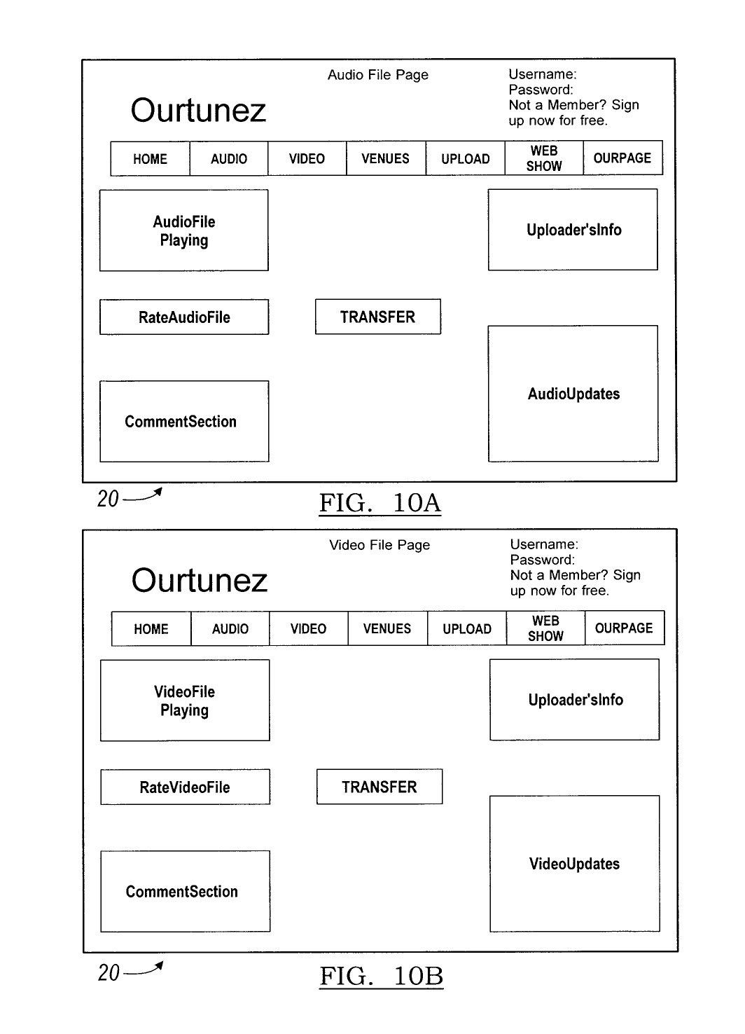

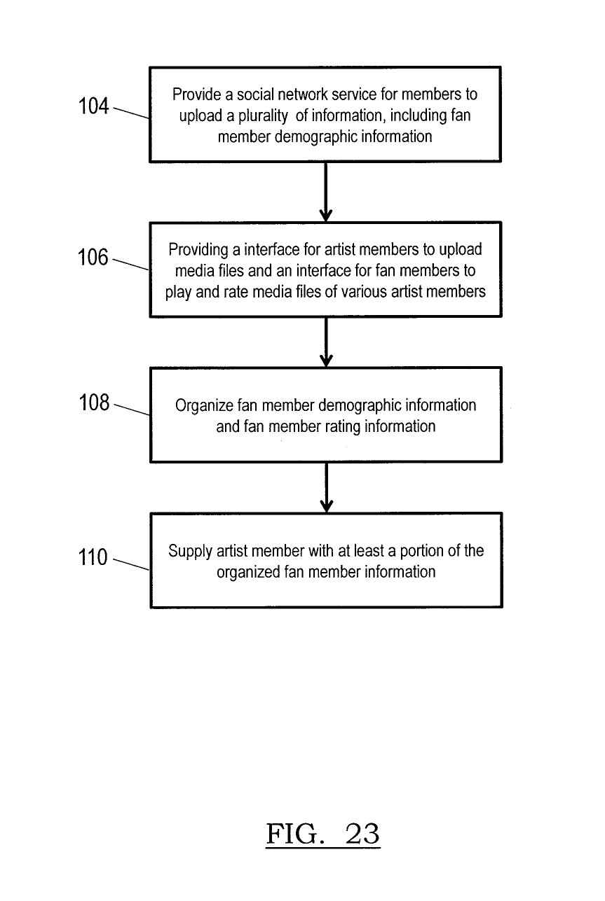

Furthermore, as illustrated in FIGS. 10A and 10B, the present invention further provides an audio file page and a video file page. In addition to the audio file page and the video file page, each individual audio or video file may have its own respective homepage 24. The present invention contemplates a method by which members may provide artists with real time, or near real time comments with respect to media files provided on either a homepage 24 of the media file, or a homepage 24 of a member. The purpose of comments may be for criticism, general discussion, and the like. The present invention further provides a rating system for media files. Specifically, members may vote or input a value with respect to an audio file or video file provided on the homepage 24 of a member. The social network service 20 may aggregate votes or values inputted for the media file in order to produce a total or average. The social media network service 20 may also compile demographic information of the commenting members and a song counter to keep track of the number of plays for a particular media file. The social network service 20 may use the total or average comments, rating information, play counter and compiled demographic information, collectively the feedback, to compare other media files to one another for promotional purposes and the like as shown in FIG. 23.

As illustrated in FIG. 23, the social network service 20, at 104 can provide a social network service 20 for members 12 to upload a plurality of information, including fan member demographic information. At 106, the service 20 can provide an interface for artist members to upload media files and an interface for fan members to play and rate media files of various artist members. The service 20 at 108 can organize fan member demographic information and fan member rating information. This organized information can be supplied to artist members in whole or in part by the service 20 at 110.

The social media network 20 may provide to artist members the feedback in order to better inform the artist members about their fan base. In one embodiment, the feedback may be compiled into individual reports 88 as shown in FIG. 21. The reports 88 as shown in FIG. 21 are organized by media file and provide artist members with demographic information, a map showing where fans live, royalties received from downloads, and a mainstream artist column. The mainstream artist column provides a drop down list of mainstream artists which are similar to the artist member. The list is sorted by relevance so that the most similar artist is displayed at the top. Armed with this information artist will be able to better market themselves to their audience and performance venues, and more efficiently grow their fan base.

The present invention envisions paying royalties to its artist members for their audiovisual works uploaded on the social network service 20. The royalties are based on number of plays or downloads of the works by members on the social network service 20.

The social network service 20 provides a means by which a member may access audio files and video files of other members by utilizing a search tool 44. The search tool 44 allows members to search for media files by inputting search criteria. Search criteria may include, but is not limited to, member user name, member interests, media file title, genre, or any other suitable information. Search criteria may be specific to artists, performers, entertainers, musicians, and venues. The social network service 20 may provide search results uncovered as a result of the search criteria inputted by a member. The search results may provide a link to access the media files uncovered during the search. Specifically, the link may provide a connection to a page dedicated to the media file, or alternatively, to a homepage 24 of a member who has provided the electronic information. A member may also transfer electronic information uncovered during a search to the homepage 24 of the member. In addition, a member may listen or view electronic information uncovered during a search directly from the search results.

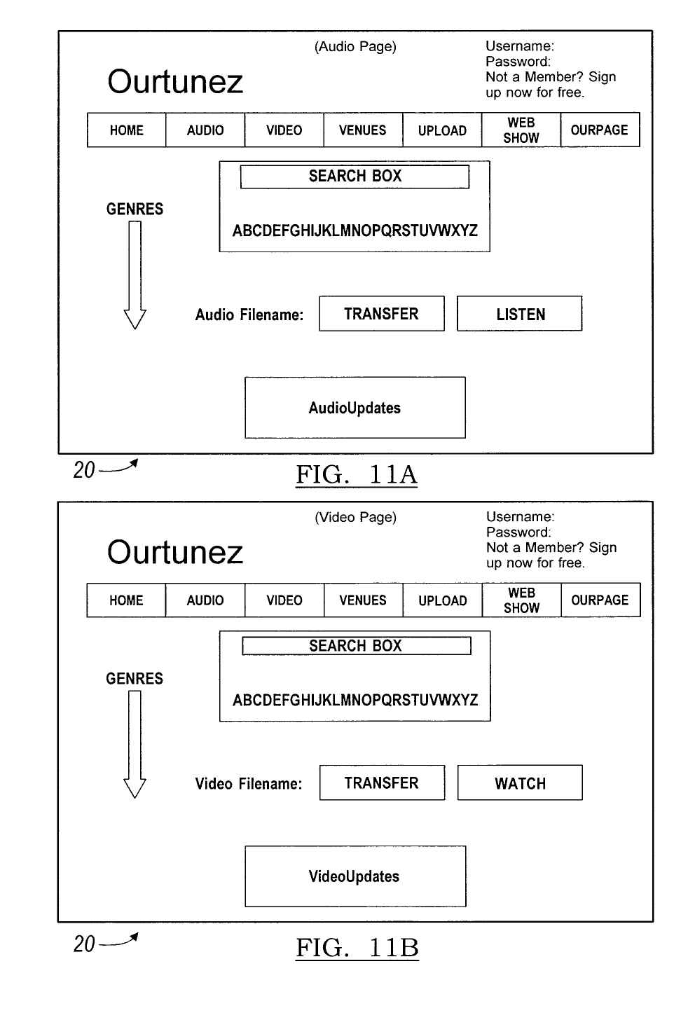

FIG. 8 illustrates one possible way of using search tool 44. A user 12 goes to the main page 26 at 46. From the main page 26 a user 12 can type in a song name into the search bar as shown at 48. Next to user 12 can click on the song name and proceed at 50 or the user can click play button at 60. If the user clicks on song name the service 20 can take the user to the audio file page at 52. At the audio file page a user can select add to play list button as shown at 54. After selecting the add button the service 20 transfers the audio file to the user's 12 homepage 24 as shown at 56 and 58. If at 48 the user 12 instead clicks the play button at 60 the service 20 can play the selected song in a media player as shown at 62. FIGS. 11A and 11B illustrate exemplary screen shots of the audio file search page and the video file search page.

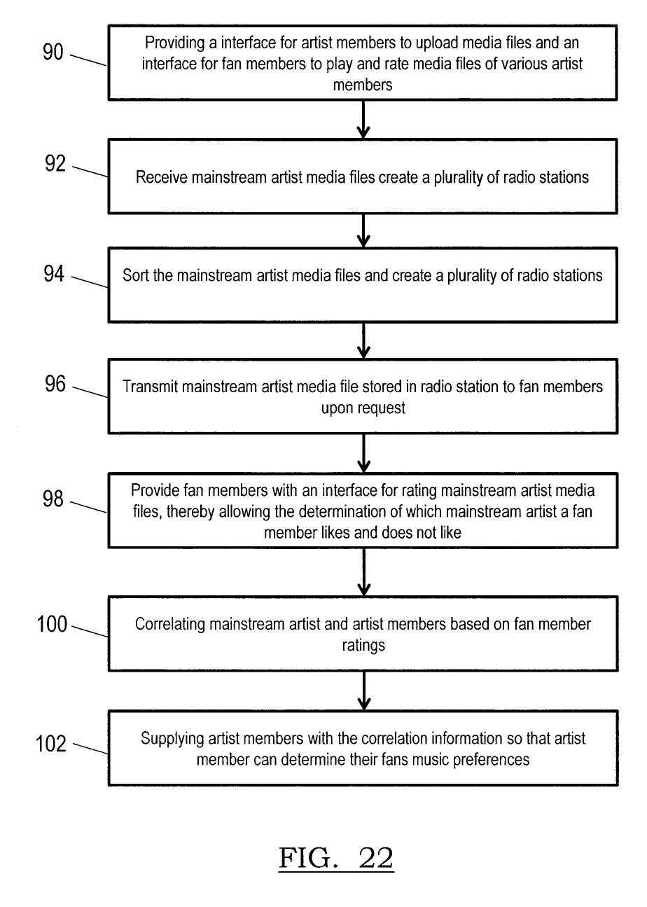

According to an embodiment of the present application, the social network service 20 provides members with a means to stream musical works through a radio station play mode. A radio station is a compilation of musical works chosen by the social network service host based on certain parameters. The parameters could be genre, artist, album, era and geographic location of the artist. The present application envisions the radio station musical works to comprise both popular mainstream works and artist member works. In radio station play mode members chose a radio station from a plurality of provided radio station choices. Once members select a radio station, the social network service 20 transmits the electronic media files from an electronic database to a member's remote terminal 12 via a computer network 18. Members have the ability to rate and comment on musical works during radio station play. The social network service can store and organize this information to determine which specific mainstream artists a fan member likes and to determine a fan member's general musical preference. The correlation of mainstream media and artist member media is done in a computer implemented program of the type described in U.S. Pat. No. 7,962,482 which is incorporated by reference herein. A flow chart of this process is illustrated in FIG. 22. The social network service 20 at 90 can provides an interface for artist members to upload media fileS and an interface for fan members to play and rate media files of various artist members. The service 20 at 92 can receives mainstream artist media files that can be used to create a plurality of radio stations. The service 20 can sort the mainstream artist media and create a plurality of radio stations at 94. The service 20 can transmit artist media files stored in a radio station to fan members upon request as is show at 96. The service 20 at 98 can provide an interface for rating mainstream artist media files. The rating of mainstream artist media files allows the service 20 to determine which mainstream artist a fan member likes and does not like. At 100, the service 20 can correlate mainstream artists and artist member based on fan member ratings. After correlating, the service 20 can supply artist members with the correlation information so that artist members can determine their fans music preferences as is shown at 102. This fan member information can be provided to the artist members to inform them of the musical preferences of their fans. This information can be added to the feedback information described previously and incorporated into an artist member's feedback report 88 as shown in FIG. 21. The present application envisions the periodic playing of artist member works based on the fan member's musical preferences. The present application also envisions radio station play mode to include the periodic playing of advertisements. The advertisements can either be global advertisement or targeted advertisement as described herein.

According to an embodiment of the present application a computer system is used to implement a method for informing artist members about which mainstream artists their fans like. The method uses a computer implemented program to stream media files of both artist members and mainstream artists to fan members upon request and to allow fan members to rate each media file. A computer implemented program then compiles the fan member ratings by fan member for both mainstream artist and artist members. The compiled fan member ratings are then correlated based on fan member ratings. The correlated data can be used to inform artist member of which mainstream artist they sound like and inform artist member of the mainstream artist their fans like. This information is very useful, for example it could allow artist members to determine which artist they should tour with.

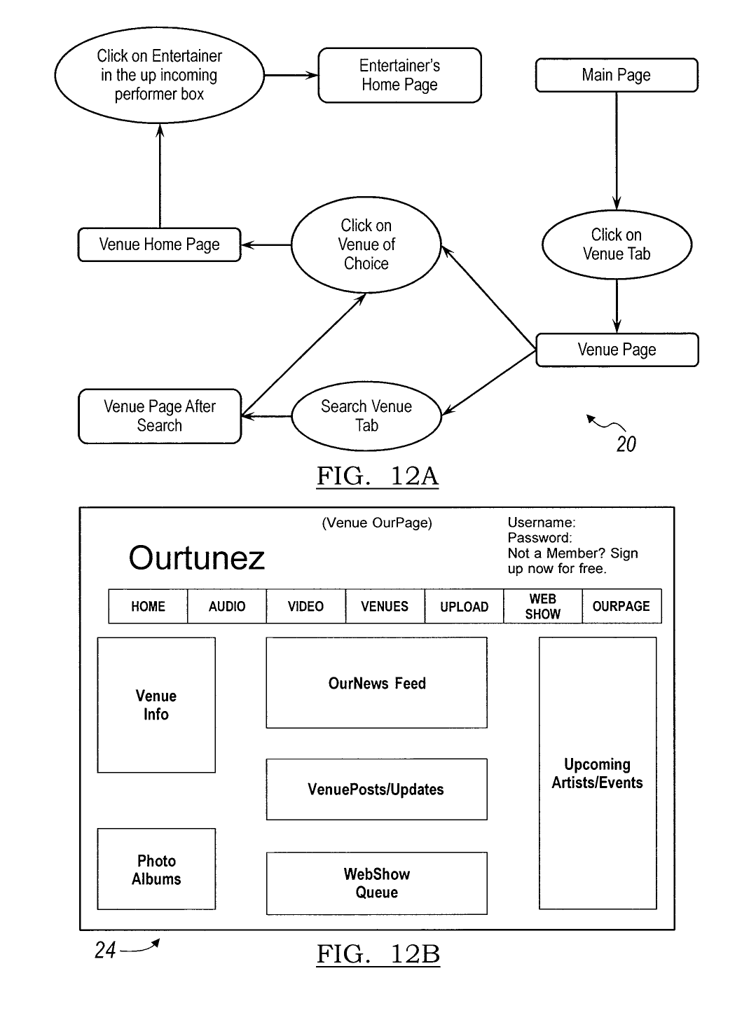

According to an embodiment of the present invention, as illustrated in FIGS. 12A and 12B, the homepages 24 of members who are classified as venues may be searched and visited through an interface. Specifically, the interface is provided to allow a gateway for artists, performers, entertainers, and musicians to effectively communicate and network with venues. Specifically, the interface is a web page that enables members to search venues according to specific search criteria. Alternatively, the web page may enable promotion of select venues by the social network service 20 on the web page. A member may enter the homepage 24 of the venue by selecting the venue from the interface. The homepage 24 of the venue may display a list of members who are artists, performers, entertainers, or musicians who will perform at the venue in the future. A member may access the homepage 24 of any of the members scheduled to perform at the venue in the future. In addition, the homepage 24 may provide updates from venues relating to changes in the venue, upcoming performances at the venue, and the like. As such, the social network service 20 provides an integrated structure designed to enable artists, performers, entertainers, and musicians to easily and effectively network with and promote to venues.

As described above, a member may access electronic information, such as media files, of other members through a variety of means provided by the social network service 20. As shown in FIG. 16, a member may transfer media files from the homepage 24 of another member who provided the media file to the homepage 24 of the member who desires the media file. As used herein, the word “transfer” does not necessarily signify a relocation of a media file. Specifically, “transfer” is broadly contemplated as creating a link between the media file on the homepage 24 of the other member who provided the media file and the homepage 24 of the member who searched for the media file. Allowing transfer of media files enables members of the social network service 20 to promote their work across the social network service 20 to other members effectively. Furthermore, each time a media file that has been transferred from a homepage 24 is played, web traffic to and from the homepage 24 is increased. As such, there remains an opportunely to implement advertising schemes that, in return for increased web traffic, pay for screen space on the homepage 24.

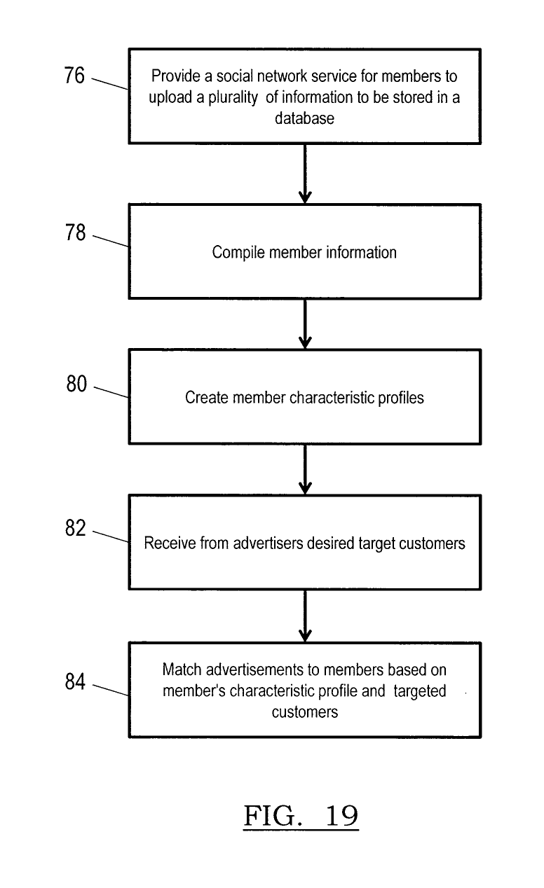

The social network service 20 provides the social network service host with a significant amount of member information including but not limited to member demographic information, member comments, artist ratings and fan member tracking information. This information is highly valuable for advertising purposes. As illustrated in FIG. 19, the member information can be compiled and categorized to create a member characteristic profile. As illustrated in FIG. 19 at 76, the system 10 provides a social network service 20 for members or users 12 to upload a plurality of information to be stored in a data base. The service 20 can then compile member information at 78. The service provider at 80 can create member characteristic profiles. At 82 the service can receive form advertisers desired target customers. The service 20 can then match advertisements to the members 12 based on the member's characteristic profile and targeted customers of the particular advertisement as shown at 84.

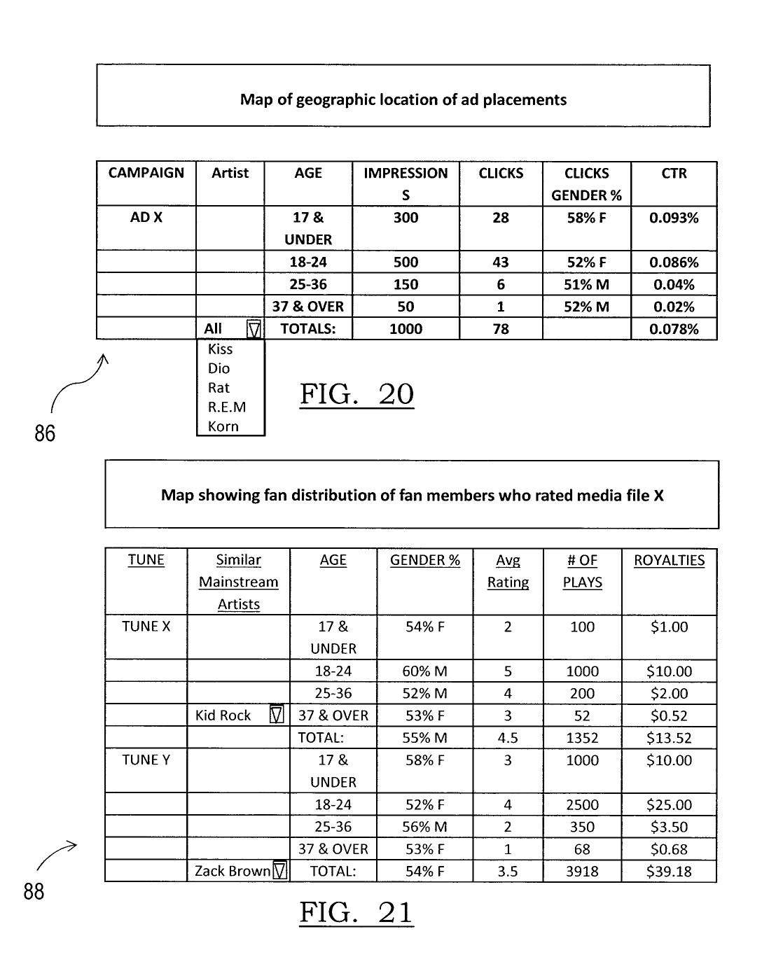

This correlation is done in a computer implemented program of the type described in U.S. Pat. No. 7,962,482 which is incorporated by reference herein adapted to match advertiser target customers with fans of artist member media. The member characteristic profile is a collection of member information arranged in a format to allow advertisers to determine suitable targets for advertisements. In one embodiment the characteristic profile could include fan member demographic information and fan member rating information for both artist members and mainstream artist. The member characteristic profile can be used to match specific advertisements to members based on the advertiser's desired target customer. Unlike conventional advertising, where advertisers either guess at possible targets or place advertisements globally in hope of reaching targets, the guess work is minimized. This approach has many advantages for both the host and the advertisers. For example, it increases efficient use of advertising space as compared to global advertising by displaying different advertisements on different member home pages based on member characteristic profiles. Alternatively, different audio advertisement can be played to different members based on member characteristic profiles. This allows the web site host to charge a higher rate per advertisement. This method is also more cost effective for advertisers because it allows them to only pay for advertisements that are displayed to members that meet a targeted demographic. According to one embodiment the social network service 20 can provide a periodic report 86 to advertisers summarizing the advertising activities for a given time period. The report 86 shown in FIG. 20 can include, impressions, clicks, click through rate, and sell through. The report 86 shown in FIG. 20 can be broken down by artist. For example an advertiser could only view advertisement statistics for fan members who like a particular artist or alternatively they can view by all artists. The advertisers can manipulate the report 86 by changing the artist using the artist dropdown as shown in FIG. 20.

According to an embodiment of the present application a computer system is used to implement a method for preforming the targeted advertising as described above. The method would implement a computer system to host a social network service and enable fan members to input content such as demographic information and media file ratings. A computer implemented program would then create a characteristic profile for each member. A computer implemented program would then compile all of the member information into a characteristic profile, match the characteristic profile to the provided advertiser target customer, display the advertisement to members on the social network service 20 and supply to the advertisers a summary of their ad placements.

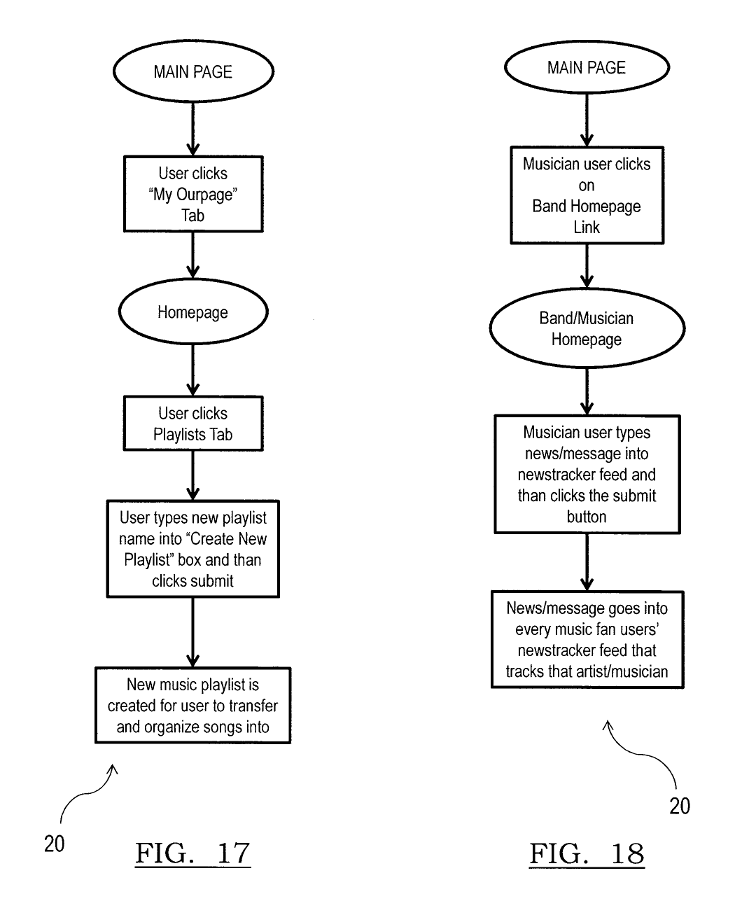

As illustrated in FIGS. 8 and 17 members may create a playlist of media files accessible from, at least, the homepage 24 of the member. The playlist is a customized selection of media files which a member may manage using the social network service 20. In addition, the media files may be grouped or categorized within the playlist. The playlist enables the member to play back the media files in an order specified by the member or in a shuffle mode. Playlists can be transferred between members who are friends with each other.

As illustrated in FIGS. 2C and 2D the social network service 20 also provides the members with a means to notify administration of the social network service 20 upon discovering media files which may be inappropriate. As such, administration may review the media file which may be inappropriate and elect to remove the media file from the social network service 20, and ultimately the server 22. The term “inappropriate” is broadly defined to cover media files containing nudity or pornography, media files with excessive gore or violent content, media files with racist or hate speech, media files which violate another party's intellectual property rights, and the like. Enabling the members of the social network service 20 to regulate one another maintains integrity of the social network service 20 for its intended purpose.

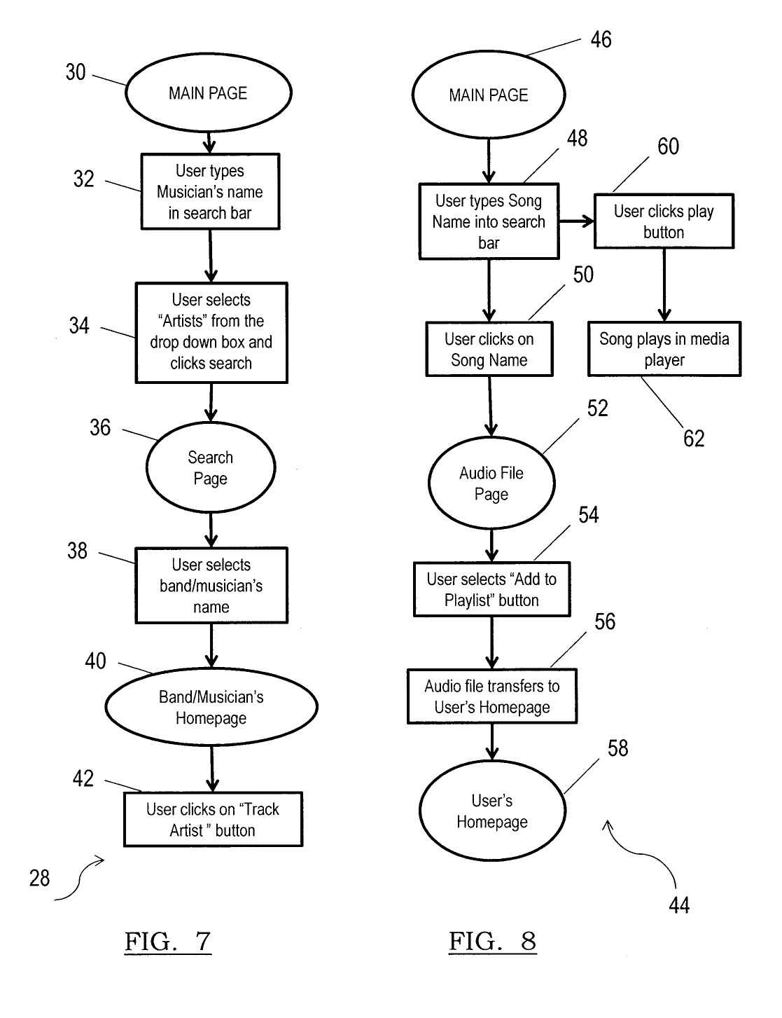

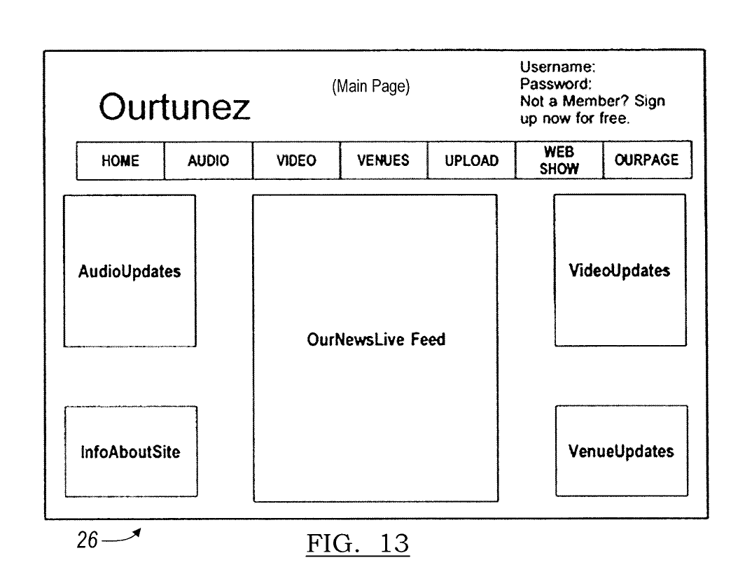

The social network service 20 further provides a means to update members of the social network service 20 regarding news or other information which may interest a member, including a scrolling banner with information about artists who are members of the social network 20. Specifically, updates may be provided on the homepage 24 of the member as shown in FIG. 18. Alternatively, updates may be provided on a main page 26 of the social network service 20, as illustrated in FIG. 13. The main page 26 is a common interface which members of the social network service 20 may access for information about the social network service 20, updates regarding media files, and the like. Updates may be implemented as real-time feeds so members may immediately be informed of updates. It is to be appreciated that updates may be provided on any suitable homepage 24 or interface of the social network service 20. As illustrated in FIG. 7, the social network service 20 also has a news tracker feature 28 allowing fan members to select artist members they like and track them. The news tracker feature displays updates and news for the selected artist members on a fan member's homepage 24. FIG. 7 illustrates one possible sequence for tracking an artist. A user or member 12 can go to the main page 26 at 30 and enter in a musician's name in a search bar as shown at 32. At 34, the service 20 can provide a drop down box allowing a user 12 to select an artist and click search. The service at 36 can then take the user 12 to a search page. At 38 the user 12 can select a band or musician. After the user selects a band or musician the service 20 can take the user 12 to the selected band or musicians home page as shown at 40. The service 20, at 42, can enable the user 12 to click track artist button.

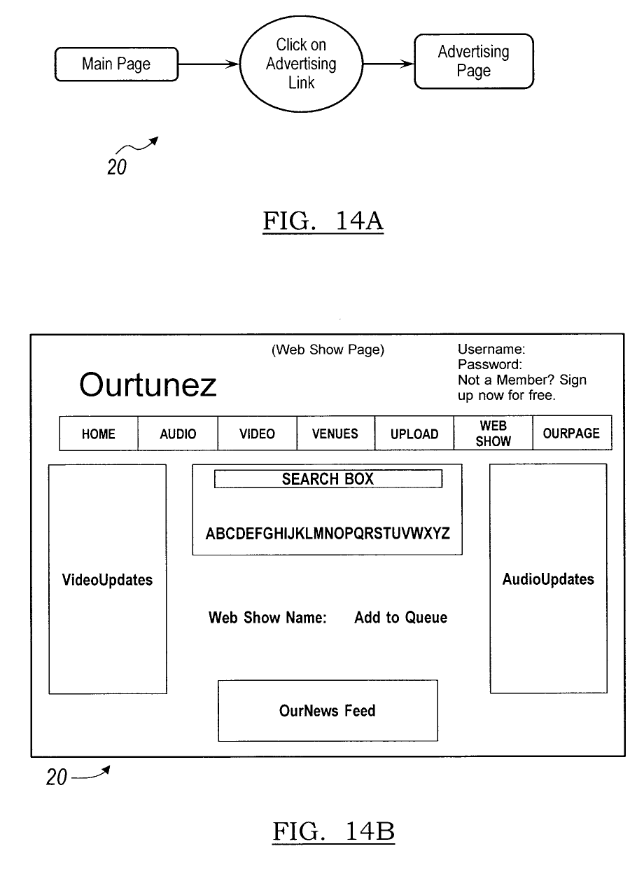

As illustrated in FIG. 14B, the present application further provides a means for members to provide a broadcast of at least one live event whereby the broadcast is accessible by other members of the social network service 20. A suitable example of the broadcast includes a live performance, such as a musical performance, or the like. The live performance may be performed by artists, performers, entertainers, musicians. Similarly, venues may broadcast live performances for promotional purposes. The broadcast may be searched by members of the social network service 20 by a means provided by the social network service 20. Suitable criteria for searching may include, but is not limited to, category of performance, date or time of performance, title of event or performer, and the like. The social network service 20 further provides a means by which a member may queue upcoming broadcasts. As such, once the upcoming broadcast is scheduled to go live, the social network service 20 may notify, and/or broadcast the event in any suitable manner known in the art.

The social network service 20 further provides a means for members to communicate to other members of the social network service 20 through an electronic mail service. Specifically, the electronic mail service provides a means of exchanging digital messages from an author to one or more recipients. Whereas electronic information provided on a member homepage 24 may be publicly viewable, the electronic mail service provides alternative private form of communication between the author and recipients. For example, an upcoming entertainer may want to contact a venue privately to determine whether the venue has a date available for the upcoming entertainer to perform.

Furthermore, the social network service 20 provides a means for members to communicate to other members of the social network service 20 through an instant messaging service. The instant messaging service provides real-time direct text-based communication between two or more members. Similar to the electronic mail service, the instant messaging service provides a private form of communication in lieu of a public homepage 24.

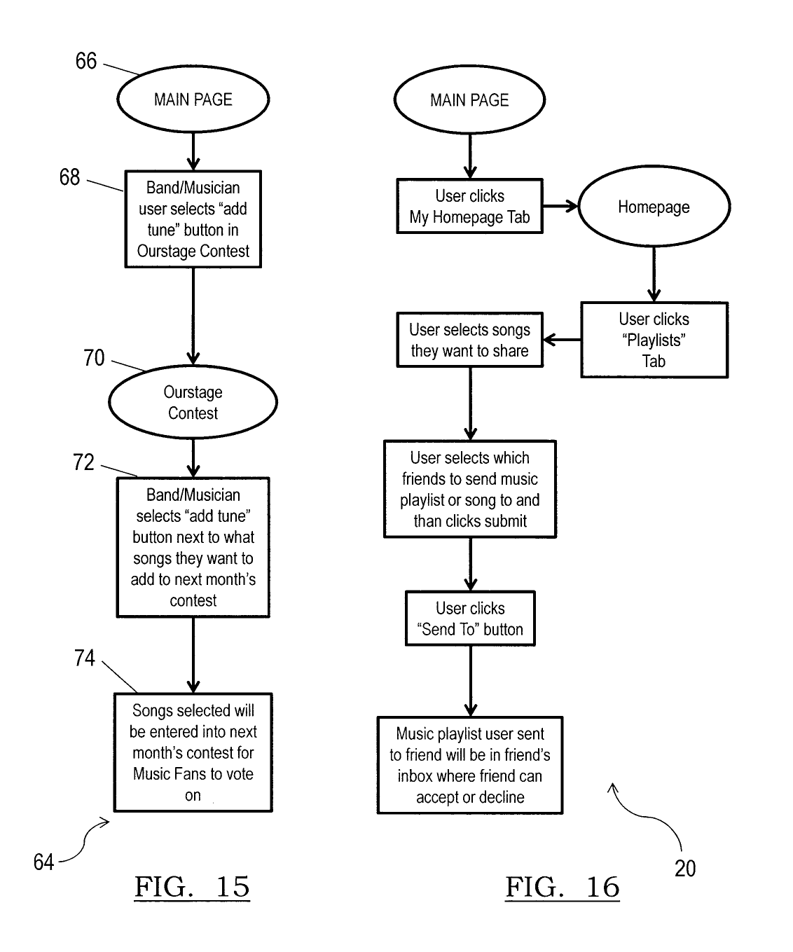

As illustrated in FIG. 15, the social network service 20 provides a way to host periodic music competitions 64 where artists members enter their works in the competition and fan members of social network service 20 vote to determine the winner. The winner receives additional exposure on social network service 20 as well as on other social media websites and blogs such as Twitter, Facebook and OURTUNEZ blog. To enter contest 64 a band or artist member 12 goes to main page 26 at 66 and selects add tune button as shown at 68. The service 20 then takes the band or artist member to the contest page 70. At 72 the band selects the add tune button next to the song the member wants to enter into next month's competition. The social network service 20 can then at 74 enter the song into next month's contest for music fans to vote on.

The present application further provides a method for promotion and networking of at least artists, performers, entertainers, musicians, and venues, the method comprising the steps of providing a social network service 20 wherein at least artists, performers, entertainers, musicians, and venues may become members of the social network service 20, and providing a server 22 wherein the server 22 hosts the social network service 20.

What is claimed is:

1. A method for promoting artists through a social network service website, the method comprising:
hosting a social network service having a website for social interaction of a plurality of members including at least artist members and fan members, the website providing members access to content stored in a server having one or more databases connected to a computer network and accessible to members, wherein the website includes a main page and a plurality of homepages, the website providing an interface for members to input demographic information, an interface for artist members to upload media files, and an interface for fan members to play and rate media files of various artist members;
organizing the fan member demographic information and fan member rating information for rated media files; and
supplying artist members with a summary of at least a portion of the demographic and rating information provided by fan members.

2. The method of claim 1 wherein hosting a social network service further comprises providing an interface for members to transfer media files between member homepages; and providing an interface for members to view which media files other members are playing.

3. The method of claim 1 wherein hosting a social network service further comprises:
providing an interface for artist members to enter their works into a contest;
providing an interface for fan members to vote; and
selecting a winner based on fan member voting.

4. The method of claim 1 wherein hosting a social network service further comprises receiving from artist members live video feed; and transmitting the artist member live video feed to fan members upon request.

5. The method of claim 1 further comprising:
creating a characteristic profile for fan members based on the demographic information and media file ratings;
receiving advertisements from advertisers geared toward a target customer having a desired characteristic profile;
matching advertisements to fan members based on an advertiser's target customer and fan member's characteristic profile;
presenting the matching advertisements to fan members while on the website; and
reporting to the advertiser a summary of their advertisement placements.

6. The method of claim 1 wherein hosting a social network service further comprises displaying news updates on the website.

7. The method of claim 1 wherein hosting a social network service further comprises providing an interface for members to create a playlist on their homepage.

8. A computer system for promoting artists through a social network service website that provides for social interaction of a plurality of members including at least artist members and fan members, the system comprising:
a database; and
a computer in electronic communication with the database for hosting a social network service website the computer having a processor for executing machine instructions and a memory for storing machine instruction that are to be executed by the processor, the machine instructions when executed by the processor implement the following instructions:
receiving at least one media file uploaded to the social network service website by an artist member;
receiving demographic information for each fan member for storage in the database;
streaming the media file to at least one fan member, in response to a fan member request;
receiving rating information for the streamed media file from the fan member;
correlating the fan member demographic information and the fan member rating information with the media file; and
outputting a report including at least one of the fan member demographic information and the fan member rating information associated with the media file to the artist member.

9. The computer system of claim 8 wherein the machine instructions further include receiving a transfer request from a fan member desiring to place a media file to another members homepage and transfer the requested media file.

10. The system of claim 8 wherein the machine instructions further include:
receiving at least one media file uploaded to the social networking service website by an artist member for entry into a music contest;
receiving votes for media files entered into the music contest from at least one fan member who judged the media file;
tallying the received votes for each media file; and
selecting a winner based on the tallied votes.

11. The system of claim 8 wherein the machine instructions further include:
receiving a live audiovisual feed from an artist member;
displaying a link to the live audiovisual feed on the social networking service website; and
streaming the live audiovisual feed to at least one fan member upon request.

12. A method for targeted advertising comprising:
hosting a social network service enabling fan members to input their demographic information and play and rate media files;
creating a characteristic profile for fan members based on the demographic information and media file ratings;
receiving advertisements from advertisers geared toward a target customer having a desired characteristic profile;
matching advertisements to fan members based on an advertiser's target customer and fan member's characteristic profile;
presenting the matching advertisements to fan members while on the website; and
reporting to the advertiser a summary of their advertisement placements.

13. The method of claim 12 wherein the summary includes a computer generated report displaying impression, clicks and click through rate.

14. A computer system for targeted advertising on a social network service website comprising:
a database; and
a computer in electronic communication with the database for hosting a social network service website the computer having a processor for executing machine instructions and a memory for storing machine instruction that are to be executed by the processor, the machine instructions when executed by the processor implement the following instructions:
receiving at least one media file uploaded to the social network service website by an artist member;
receiving demographic information from fan members for storage in the database;
streaming the media file to at least one fan member, in response to a fan member request;
receiving rating information for the streamed media file from the fan member;
creating a fan member characteristic profile for at least one fan member based on the fan member demographic information and the fan member rating information;
receiving advertisements from advertisers geared toward a target customer having a desired characteristic profile;
matching advertisements to at least one fan member based on an advertiser's target customer and the fan member's characteristic profile;
presenting the matching advertisements to at least one fan member while on the social networking service website; and
reporting to the advertiser a summary of their advertisement placements.

15. A method of promoting independent artist comprising:
hosting a social network service having a website for social interaction of a plurality of members including at least artist members and fan members, the website providing members access to content stored in a server having one or more data bases connected to a computer network and accessible to members, wherein the website includes a main page and a plurality of homepages, the website providing an interface for members to input demographic information, an interface for artist members to upload media files, and an interface for fan members to play and rate media files of various artist members;
creating a radio station being a plurality of mainstream artist media files;
transmitting media files from a server to member remote terminals through a computer network, wherein the transmitting is in response to a member input;
providing fan members with an interface for rating mainstream musical works during radio station play, thereby allowing a social network service host to determine which mainstream artists a fan member likes;
correlating mainstream artists and artist members based on fan member ratings; and
supplying artist members with the correlation information so that artist members can determine their fan members mainstream artist preferences.

16. The method of claim 15 further comprising transmitting content to fan members based at least in part on fan member demographic information and correlation between mainstream artist and artist members.

17. A computer system for promoting artists through a social network service website that provides for social interaction of a plurality of members including at least artist members and fan members, the system comprising:
a database; and
a computer in electronic communication with the database for hosting a social network service website the computer having a processor for executing machine instructions and a memory for storing machine instruction that are to be executed by the processor, the machine instructions when executed by the processor implement the following instructions:
receiving at least one media file uploaded to the social network service website by an artist member;
transmitting the artist member media file to at least one fan member, in response to a fan member request;
receiving rating information for the transmitted artist member media file from the fan member for storage in the database;
organizing the fan member media file ratings by artist member thereby determining a fan members general impression for at least one artist member;
receiving a plurality of mainstream artist media files;
organizing the mainstream artist media files to create a plurality of radio stations for storage in the database;
transmitting the at least one mainstream artist media file to at least one fan member, in response to a fan member request;
receiving rating information for the transmitted mainstream artist media file from the fan member;
compiling the rating information for all mainstream artist media files rated by a fan member thereby determining which mainstream artist the fan member likes and does not like;
correlating mainstream artist and artist members based on fan member ratings; and
supplying artist members with the correlation information so that artist members can determine their fan members main stream artist preferences.
